(19) United States
(12) Patent Application Publication
(10) Pub. No.: US 2006/0292282 A1
(43) Pub. Date: Dec. 28, 2006

(54) Color-Changing Alcoholic Beverages Using Plant Anthocyanins

(76) Inventor: Perry Matthew Stilson, Hercules, CA (US)

Correspondence Address: CENTRAL COAST PATENT AGENCY, INC, 3 HANGAR WAY SUITE D, WATSONVILLE, CA, 95076, US

(21) Appl. No.: 11/425,928

(22) Filed: Jun. 22, 2006

Related U.S. Application Data
(60) Provisional application No. 60/692,776, filed on Jun. 22, 2005.

(51) Int. Cl. C12H 1/14

(52) U.S. Cl. 426/592

(57) ABSTRACT

A method for providing an alcoholic beverage that exhibits color-change has steps for immersing a quantity of flowers, sans stems, in a quantity of an alcoholic beverage, allowing time for alcohol in the beverage to break down cells of the flowers, and straining the resulting mixture.

### CROSS REFERENCE TO RELATED DOCUMENTS

The present case claims priority to Provisional Patent Application 60/692,776, filed on Jun. 22, 2005, and incorporates the content of that application at least by reference.

### BACKGROUND OF THE INVENTION

1. Field of the Invention

The present invention is in the area of modifications to alcoholic beverages to create visual identity and to provide a level of entertainment or mood alteration.

2. Discussion of the State of the Art

It is well known that there are a variety of alcoholic beverages in the art, and that different ones or types of alcoholic beverages may have different colors, but each type has a typical color. Vodka, for example is typically clear, or colorless, and bourbon whiskey is typically semi-transparent and amber in color. It is also known that there is considerable competition among manufacturers of such beverages to reach a target market and accomplish sales as market share. Ways of presenting such beverages to potential customers in a pleasing way can therefore enhance market share, and a new method for providing color change, and new and unusual colors in such beverages can provide a marketing advantage.

### SUMMARY OF THE INVENTION

In one embodiment of the invention a method for providing an alcoholic beverage that exhibits color-change, is provided comprising steps of (a) immersing a quantity of flowers, sans stems, in a quantity of an alcoholic beverage, (b) allowing time for alcohol in the beverage to break down cells of the flowers, (c) straining the resulting mixture.

In one embodiment there is a further step for freezing the resulting beverage for storage, to avoid breakdown of anthocyanins in the beverage. In yet another embodiment there is a step for adding water to adjust the composition and color of the beverage. In still another embodiment there is a step for adding a source of edible acid to raise the pH of the beverage to change the color. The source of acid may be a citrus juice.

In another aspect an alcoholic beverage that exhibits color-change is provided, comprising anthocyanins absorbed in the beverage from flowers and a quantity of water added to adjust composition and color.

### BRIEF DESCRIPTION OF THE DRAWING FIGURES

There are no drawing figures accompanying the present specification.

### DETAILED DESCRIPTION OF THE INVENTION

The present inventor has accomplished and recorded a process for creating color-changing alcoholic beverages by infusing ethanol alcohol in such beverages with elements from edible flowers. The change in the color of a resulting beverage, which is from green to pink in an embodiment described below in enabling detail, is catalyzed by a drop in ph level, caused by addition of citric acid in lime juice to the beverage. This process creates an alcoholic beverage which is easily recognizable, and the appearance is entertaining.

The color-changing property of the resulting beverage is due to the presence of anthocyanins, naturally occurring chemical compounds which are responsible for the color of plants, flowers, and fruits. A resulting beverage from the process described by example below is suitable for consumption without further processing.

The method described herein by example for extracting plant anthocyanins differs from previous methods of extraction. This method is specifically designed to create a beverage which will change color in a specific manner when its ph level is altered.

The following is an example of a process according to an embodiment of the present invention which creates a highly palatable resulting beverage with dramatic green to pink color-changing characteristic.

Pansies (Viola×Wittrockiana) which are typically blue or purple in color with a velvet-like texture are fully immersed in high quality eighty proof vodka in a sealed container made of glass, plastic, stainless steel, or other suitable material. It is important to note that the whole flower including the base but not the stem, is used, and that the flowers should be gently yet thoroughly rinsed and very fresh. The ratio of flowers to vodka in this example is about fifty whole pansies (approximate weight about thirty grams, to 1.2 liters of vodka, To begin the infusion process, the flowers are placed in a container, then the vodka Is gently poured over the flowers. The dimensions of the container should be such to allow the flowers to be fully immersed at this ratio. The container is then sealed, and left to sit at room temperature, about 70 degrees Fahrenheit for a duration of about four hours. During this time the alcohol breaks down the cells of the flowers, and the anthocyanins, as well as other chemical

compounds of the flowers are absorbed into the liquid of the beverage. The liquid is then strained, separating the liquid from the flowers. The strained liquid is then filtered to remove any remaining plant particles. The resulting liquid is of a medium blue to purple color. This liquid is then mixed with about 0.8 liters (800 ml) of water, preferably pure. This process raises the ph of the solution to a level near 6, at which point the liquid is a pale green color, which is now about 24% alcohol by volume. The beverage is at this point ready to be bottled and either served or stored. If stored the liquid should be frozen to prevent breakdown of the anthocyanins. A solution &at is 24% alcohol by volume will freeze around nine degrees Fahrenheit.

In an alternative embodiment about seventy pansies, which is about forty grams, are used per liter of eighty proof Vodka, which is then diluted to about twenty-seven percent alcohol by volume. In this embodiment the resulting vodka is bluish green instead of just green, but turns the same bright pink with addition of acid from such as citrus fruit. This beverage may also be mixed with tonic water or seven-up to turn more of a clear pink color.

Following are examples of how this beverage might be served to demonstrate the color-changing characteristics:
Martini (up)—2 ounces of the resulting liquid from the process described above sweetened, to taste with sugar or a sugar substitute, shaken with ice in a cocktail shaker, then strained into a martini glass. The sweetener and the dilution from melting ice will raise the ph slightly, enhancing the green color. At this point the liquid will be a lime green color. A wedge of lime, usually ⅙th of one lime, is then squeezed and dropped into the glass. The liquid will change from green to pink within seconds once the lime juice is adequately incorporated in the beverage, until it reaches a bright fluorescent pink magenta color. This color is also much brighter than the unreacted green color.
Rocks—The same as above, with the resulting liquid being poured into a glass with ice rather than shaken and strained.
Cocktail—Into a tall glass with ice, pour equal parts of the resulting liquid and sweet and sour mix (usually yellow to yellow/green), This turns a pale pink color.

The process described above used vodka as the source of ethanol alcohol, and Pansies as the source of anthocyanins. Other flowers, including but not limited to Snap Dragons, Nasturtiums, Peonies, and Violets may be used in this method to create beverages with color-changing characteristics. Other sources of ethyl alcohol may be used. The ratio of pansies to vodka, and the infusion time listed in the example have been found to be ideal for coloration and flavor with this combination. Results may be achieved, with varying degrees of success using a much higher or lower ratio of flowers to alcoholic beverage, and a much longer or shorter duration of infusion. The ideal ratio and duration may be different for other flowers, and for different types of ethanol. Results may be achieved with varying degrees of success by conducting the infusion at much higher or lower temperatures.

It will be apparent to the skilled artisan that many alterations might be made in the embodiments of the invention described without departing from the spirit and scope of the invention. A number of sorts of alcoholic beverages might be used in different combinations with a variety of flowers, and at different ratios of flowers to beverage. Temprerature and time variations will also affect the result. The invention is to be limited only by the scope of the claims that follow.

I claim:

1. A method for providing an alcoholic beverage that exhibits color-change, comprising steps of:
(a) immersing a quantity of flowers, sans stems, in a quantity of an alcoholic beverage;
(b) allowing time for alcohol in the beverage to break down cells of the flowers;
(c) straining the resulting mixture.

2. The method of claim 1 further comprising a step for freezing the resulting beverage for storage, to avoid breakdown of anthocyanins in the beverage.

3. The method of claim 1 further comprising a step for adding water to adjust the composition and color of the beverage.

4. The method of claim 3 further comprising a step for adding a source of edible acid to raise the pH of the beverage to change the color.

5. The method of claim 4 wherein the source of acid is a citrus fruit juice.

6. An alcoholic beverage that exhibits color-change, comprising:
anthocyanins absorbed in the beverage from flowers; and
a quantity of water added to adjust composition and color.
